(19) United States
(12) Patent Application Publication
(10) Pub. No.: US 2007/0233661 A1
(43) Pub. Date: Oct. 4, 2007

(54) Information processing apparatus, information processing method, storage medium and data signal

(75) Inventor: Hiroyuki Sayuda, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/636,577

(22) Filed: Dec. 11, 2006

(30) Foreign Application Priority Data
Apr. 4, 2006 (JP) 2006-103028

(51) Int. Cl. G06F 17/30

(52) U.S. Cl. 707/3

(57) ABSTRACT

An information processing apparatus includes an information embedding section, a feature quantity acquiring section and an information managing section. The information embedding section embeds information, which specifies content relevant to document data, into the document data. The feature quantity acquiring section acquires feature quantity information about the content. The information managing section manages the feature quantity information about the content at a time when the information is embedded into the document data, while associating the feature quantity information and the information embedded into the document data with each other.

### BACKGROUND

1. Technical Field

The invention relates to an information processing apparatus, an information processing apparatus, an information processing program and a data signal embedded with the program, which are adapted for the case where document data having link information about relevant content are printed out.

2. Related Art

In recent years, so-called hypertext documents are used broadly as electronic documents dealt with on computers. The hypertext documents are documents including links for connecting information (hereinafter referred to as “content”) such as relevant documents, image elements as constituent members of the documents such as texts, images and graphics, audio and video to the image elements. For example, PDF (Portable Document Format) famous as a document format suitable for printing can also include hyperlinks so that when an image element as a constituent member of a document is designated by a designating device called mouse during browsing on a monitor, content relevant to the image element can be browsed or reproduced immediately.

When such a hypertext document is printed out simply, information concerned with link etc. cannot be outputted on a sheet of paper directly but only visually perceivable information from information included in the hypertext document can be recorded. For this reason, an advantage (characteristic) of the hypertext document is spoiled. From this fact, there has been heretofore made a proposal that information concerned with link is embedded on each image element or in the neighbor thereof and made printable in printing out a hypertext document. Specifically, there has been made a proposal that an URL (Uniform Resource Locator) in a hypertext document described in HTML (Hyper Text Markup Language) is converted into a two-dimensionally coded image and this image is printed out after inserted immediately after a reference portion (the URL portion) (e.g. see JP Hei. 11-203381 A). With this arrangement, when, for example, the two-dimensionally coded image portion is read by a camera and the two-dimensional code in the image is analyzed and converted into the URL, access to content specified by the URL can be gained.

In addition, there has been made another proposal that link information for specifying information relevant to an image element is embedded into a rendering position of the image element while at least partially superimposed on the rendering position of the image element, so that a large quantity of information can be embedded into an image without destroying the form of any hypertext document (e.g. see JP 2001-177712 A).

When content designated by a hyperlink are changed after a hypertext document is printed out, there arises a problem that content accessible from the printed document image are different from the content at the time of printing out, i.e. expected content. For example, imagine the case where a hypertext document as shown in FIG. 4A is printed out. In the hypertext document shown in FIG. 4A, link information “http://www.abc.com/release/new.htm” is embedded in an image element portion of a character “here”. When such a hypertext document is printed out, the printed image of the hypertext document becomes an image, for example, with two-dimensionally coded link information overwritten and superimposed on a character image 21 “here” as shown in FIG. 4B. When the portion of the character image 21 is read by a camera and a two-dimensional code in the character image 21 is analyzed and converted into an URL, relevant content as shown in FIG. 4C can be accessed. When content designated by the link information “http://www.abc.com/release/new.htm” are changed after the printout date and time, the content shown in FIG. 4C cannot be accessed but different content shown in FIG. 4D are accessed even if the character image 21 of the printed image is read and analyzed after the change.

From this fact, there has been made a further proposal that content downloaded from a link designation are managed when a hypertext document is printed out so that even if there is a change in the content of the link designation after the printout, the content at the time of printing out, i.e. expected content can be accessed regardless of the change in the content (e.g. JP 2006-11777 A).

In JP Hei. 11-203381 A, JP 2001-177712 A and JP 2006-11777 A, when a hypertext document with link information embedded therein is printed out in order to make use of an advantage (characteristic) of the hypertext document, it is necessary to download content from a link destination in advance at the time of printing the hypertext document so that access to the expected content can be gained regardless of the change in the content of the link destination. Accordingly, there is a possibility that the quantity of data to be downloaded and managed may become huge depending on details of the content. This is disadvantageous in terms of necessary memory capacity, cost, etc. and there is also fear that large-scale user operation will be difficult.

### SUMMARY

According to an aspect of the invention, an information processing apparatus includes an information embedding section, a feature quantity acquiring section and an information managing section. The information embedding section embeds information, which specifies content relevant to document data, into the document data. The feature quantity acquiring section acquires feature quantity information about the content. The information managing section manages the feature quantity information about the content at a time when the information is embedded into the document data, while associating the feature quantity information and the information embedded into the document data with each other.

### BRIEF DESCRIPTION OF THE DRAWINGS

Exemplary embodiments of the invention will be described in detailed below with reference to the accompanying drawings wherein:

FIGS. 1A and 1B are explanatory views showing a system configuration in use of each information processing apparatus according to an exemplary embodiment of the invention;

FIG. 2 is an explanatory view showing a functional configuration of an information processing apparatus according to a first exemplary embodiment of the invention;

FIG. 3 is an explanatory view showing specific examples of correspondence relations between link information and hash values;

FIGS. 4A to 4D are explanatory views showing specific examples of a printed image of a hypertext document and relevant contents;

FIG. 5 is an explanatory view showing a functional configuration of an information processing apparatus according to a second exemplary embodiment of the invention;

FIG. 6 is an explanatory view showing a functional configuration of an information processing apparatus according to a third exemplary embodiment of the invention; and

FIG. 7 is an explanatory view showing other specific examples of correspondence relations between link information and hash values.

### DETAILED DESCRIPTION

An information processing apparatus and an information processing program according to exemplary embodiments of the invention will be described below with reference to the drawings. Although the following exemplary embodiment will be described on the case where a hypertext document, for example, described in HTML is printed out, it is absolutely a matter of course that the invention can be also applied to the case where another document than the hypertext document is printed out.

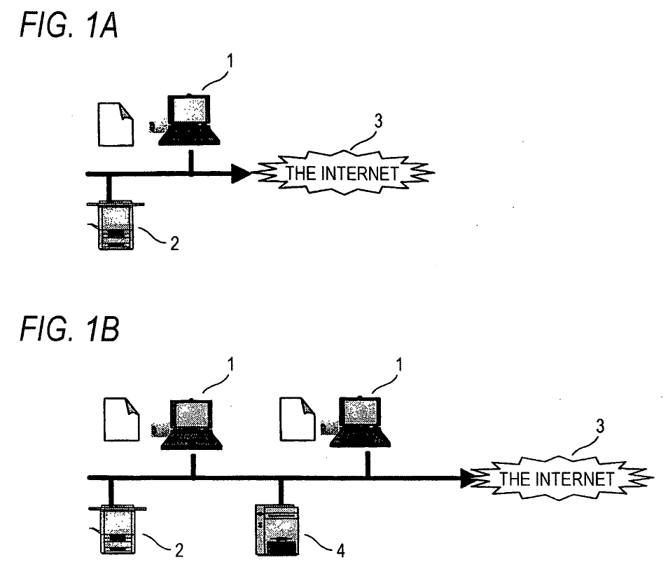

First, examples of system configuration in use of the information processing apparatus will be described. FIGS. 1A and 1B are explanatory views showing the examples of system configuration in use of the information processing apparatus. As shown in FIG. 1A, the information processing apparatus 1 mentioned here is, for example, constituted by a personal computer. The information processing apparatus 1 is used in the condition that the information processing apparatus 1 is connected to a printer apparatus 2 and the Internet 3 in order to print out document data. That is, upon reception of document data, e.g. written in HTML, the information processing apparatus 1 performs processing necessary for printing out the document data as a hypertext document on a recording medium such as a sheet of paper and then sends the document data to the printer apparatus 2 to print out the document data. Printing out from the printer apparatus 2 can be performed by a well known technique such as electrophotography or ink-jet technology. Any other image forming apparatus (such as a copying machine) may be used in place of the printer apparatus 2. Inputting of the document data into the information processing apparatus 1 can be conceived as the case where the data are inputted through a user's operation on the information processing apparatus 1 or the case where the data are inputted through the Internet 3.

Although the information processing apparatus 1 can be used in a standalone manner, the invention is also applicable to construction of a system including a server apparatus 4 having a function of a print server as shown in FIG. 1B. That is, the invention is also applicable to construction of the system including a plurality of information processing apparatuses 1, a printer apparatus 2 and the server apparatus 4 which are connected to the Internet 3.

The document data received to be processed by such an information processing apparatus 1 are data for printing out a hypertext document. The document data are assumed to include form information and link information.

The form information is for defining rendering positions of image elements as constituent members of documents such as texts, images and graphics on these hypertext documents. Although the form information is basically for defining the “appearance” of each hypertext document, there is some form information which is not for defining the “appearance” accurately but for describing the logical significances of individual image elements such as “paragraphs” in the hypertext document. Normally, a browser etc. converts logical information into form information based on a predetermined rule so that such a hypertext document can be displayed or printed. That is, in this case, the form of each image element is defined on the basis of the logical information. Accordingly, document data which only include logical information are also regarded here as document data including information for defining the form.

The link information is for gaining access to relevant contents. The link information is for connecting image elements rendered on a hypertext document to contents relevant to the image elements. The “contents” include documents relevant to the image elements as constituent members of the hypertext document, the image elements, audio, video, etc. Accordingly, when, for example, document data are written in HTML, the link information may be expressed in URLs indicating storage places of relevant contents. It is however a matter of course that the link information is not always limited to the URLs but the link information may be provided for specifying parameters such as an audio file (music file), a video file, an application, etc. The application for gaining access to relevant contents to display or play back the contents varies according to the link information. When, for example, the link information is an URL, the browser makes response to the link information. When, for example, the link information is an audio file, an application for playing back an MP3 file makes response to the link information. In addition, an application for activating a dictionary tool etc. may be listed as another example of the application.

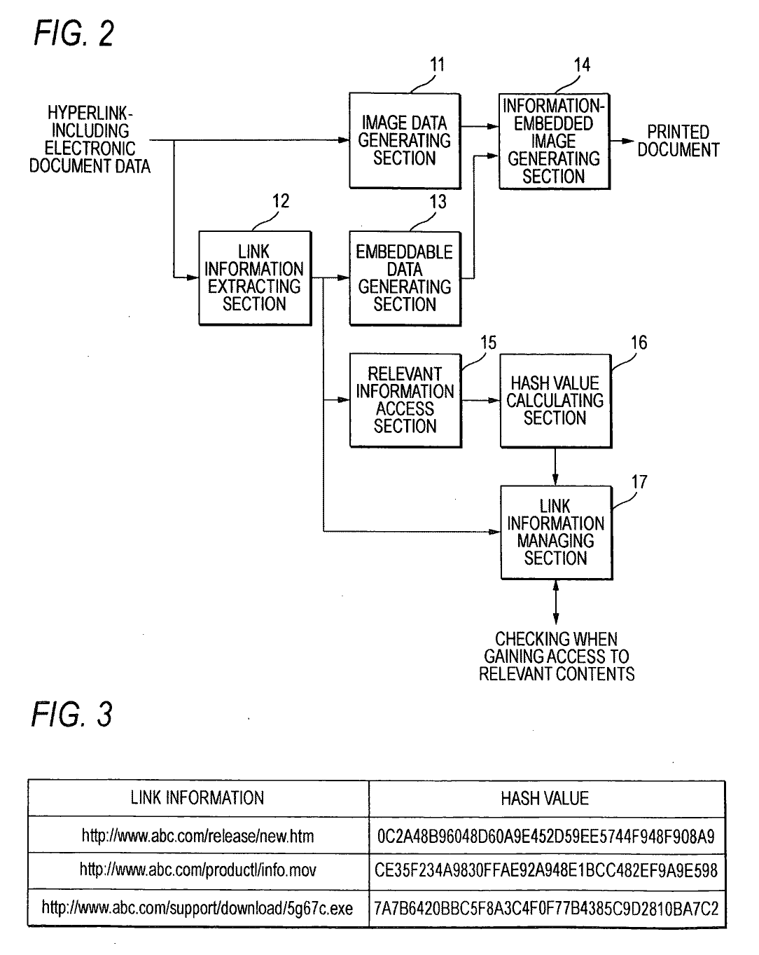

Next, an example of functional configuration of the information processing apparatus 1 used in the aforementioned system will be described. FIG. 2 is an explanatory view showing a functional configuration of the information processing apparatus according to the first exemplary embodiment of the invention.

As shown in FIG. 2, in order to print out document data as a hypertext document, the information processing apparatus 1 has functions of an image data generating section 11, a link information extracting section 12, an embeddable data generating section 13, an information-embedded image generating section 14, a relevant information access section 15, a hash value calculating section 16, and a link information managing section 17.

The image data generating section 11 generates image data in a printable form (e.g. bitmap format) from received document data by rendering the document data based on form information in the document data.

The link information extracting section 12 extracts link information included in the received document data from the document data.

The embeddable data generating section 13 converts the link information extracted by the link information extracting section 12, into data in a format embeddable in a print image. It can be conceived to use two-dimensionally coded data as the “data in a format embeddable in a print image”. Although bar codes can be used typically as an example of the “two-dimensional code”, any other codes may be used as long as the codes conform to the two-dimensional code. Specifically, for example, two-dimensional coding may be attained by changing the forms (positions, shapes, etc.) of pixels constituting a multi-lined or dot screen as gray scale representation, like a technique called “iTone” (registered trademark). That is, any two-dimensional code may be used as long as the position, arrangement relation and geometrical shape of each pixel, or a pattern formed from a plurality of pixels can be changed by coded values of the contents of the link information. Since any known technique can be used for two-dimensional coding, detailed description of the two-dimensional coding will be omitted here.

The information-embedded image generating section 14 embeds the embeddable data generated by the embeddable data generating section 13 into the image data generated by the image data generating section 11 so that the embedded data can be printed out as a hypertext document. It can be conceived that the data embedding is performed based on the form information included in the document data. Thus, the link information is superimposed on each of image elements of the hypertext document or embedded as two-dimensionally coded data in the neighbor of each image element. Since any known technique may be used for embedding data (e.g. see Patent Document 1 or 2), detailed description of the data embedding will be omitted here.

When the link information is extracted by the link information extracting section 12, the relevant information access section 15 gains access to the location (WWW server etc.) of contents specified by the link information and downloads the contents from the location.

The hash value calculating section 16 acquires feature quantity information about the contents downloaded by the relevant information access section 15 and, more specifically, calculates a hash value as the feature quantity information. The “hash value” is a value calculated on the basis of a hash function which generates a pseudo-random number having a fixed length from a given original. The “hash value” is equivalent to a feature quantity which specifies the original uniquely. Since any known technique can be used for the hash value per se and calculation of the hash value, description thereof will be omitted here. The feature quantity information calculated by the hash value calculating section 16 is not always necessarily made up of a hash value. That is, the hash value calculating section 16 may acquire any other feature quantity as long as the feature quantity can be used for specifying the contents uniquely.

The link information managing section 17 makes correspondence between the feature quantity information acquired by the hash value calculating section 16 and the information embedded in the document data by the information-embedded image generating section 14, i.e. the link information extracted by the link information extracting section 12 and stores the correspondence relation between them, for example, in a table form. That is, the link information managing section 17 manages the information embedded in the document data while making correspondence between the information embedded in the document data and the feature quantity information about the contents at the time of embedding the information into the document data.

For example, the respective sections 11 to 17 may be achieved by combination of a CPU (Central Processing Unit) for executing predetermined programs, an ROM (Read Only Memory) for storing the predetermined programs and an RAM (Random Access Memory) used as a work area for the CPU. That is, it can be conceived that the respective sections 11 to 17 are achieved by the predetermined programs executed by the computer functions of the information processing apparatus 1. Incidentally, in this case, the predetermined programs for achieving the respective sections 11 to 17 may be provided in the condition that the predetermined programs are not installed in the information processing apparatus 1 in advance but stored in a computer-readable storage medium, or may be distributed through a wired or wireless communication means. That is, the information processing apparatus 1 configured as described above can be also achieved by an information processing program provided for making the computer serve as the information processing apparatus.

Next, description will be given to an example of processing operation in the information processing apparatus having the aforementioned configuration (inclusive of the case where the information processing apparatus is achieved by the information processing program).

In this information processing apparatus (information processing program), document data to be printed out are acquired before a process of printing out a hypertext document. It can be conceived that acquisition of the document data is achieved by reception of the document data from a host apparatus through a network. Incidentally, when the information processing program makes the computer serve as the information processing apparatus, an operator working on an operating device such as a keyboard may input document data by using document-making software or document-managing software.

After the document data are acquired, the image data generating section 11 generates image data, the link information extracting section 12 extracts link information included in the document data, and the embeddable data generating section 13 codes the link information two-dimensionally. The information-embedded image generating section 14 embeds the two-dimensionally coded data into the image data so that the two-dimensionally coded data can be printed out as a hypertext document.

On the other hand, when the link information is extracted by the link information extracting section 12, the relevant information access section 15 downloads contents specified by the link information, based on the extracted link information. That is, the relevant information access section 15 downloads contents linked to the hypertext document. Since downloading of the relevant contents may be performed by use of any known technique, description thereof will be omitted here.

When the contents are downloaded by the relevant information access section 15, the hash value calculating section 16 successively calculates a hash value as feature quantity information about the contents. The link information managing section 17 makes correspondence between the hash value calculated by the hash value calculating section 16 and the link information extracted by the link information extracting section 12 and stores and holds the correspondence relation between them.

Here, description will be given to specific examples concerned with correspondence relations between link information and hash values and management thereof. FIG. 3 is an explanatory view showing specific examples of correspondence relations between link information and hash values. As shown in FIG. 3, the link information managing section 17 stores the correspondence relations between the link information and the hash values in a table form. When, for example, a calculation result of a hash value about contents downloaded based on link information “http://www.abc.com/release/new.htm” is “0C2A48B96048D60A9E452D59EE5744F948F908A9”, the link information and the hash value are registered in the table while correspondence is made between the link information and the hash value.

Incidentally, if downloading dates and times, printout dates and times, etc. of the contents are registered and managed in addition to management of the correspondence relations between the link information and the hash values, it is very suitable for effective utilization of a storage region in the link information managing section 17. Because the information storage region is generally finite, it is conceived that storage of information such as link information, hash values etc. may be not allowed any more when hypertext documents are printed out repetitively. Even in such a case, if, for example, the downloading dates and times, the printout dates and times, etc. are registered and managed, effective utilization of the finite storage region can be attained because contents which have been held for a predetermined period or longer after downloading or contents which have not been printed out for a predetermined period or longer can be deleted from the link information managing section 17.

The two-dimensionally coded link information embedded in the images of the hypertext document printed out after the aforementioned series of processes can be optically read and acquired after the printing-out of the hypertext document, so that access to the relevant contents can be gained.

Since the link information managing section 17 manages the link information while making correspondence between the link information and the hash values, details of contents obtained by gaining access to the relevant contents can be confirmed by use of the management information in the link information managing section 17. That is, when access to contents specified by the link information embedded in the printed-out document image is performed based on the link information, whether or not the contents at the time of access are the same as the contents at the time of printing out or not can be checked as long as a hash value about the contents obtained at the time of access is calculated and a result of the calculation is compared with a hash value which is managed by the link information managing section 17 and calculated from the contents at the time of embedding the link information.

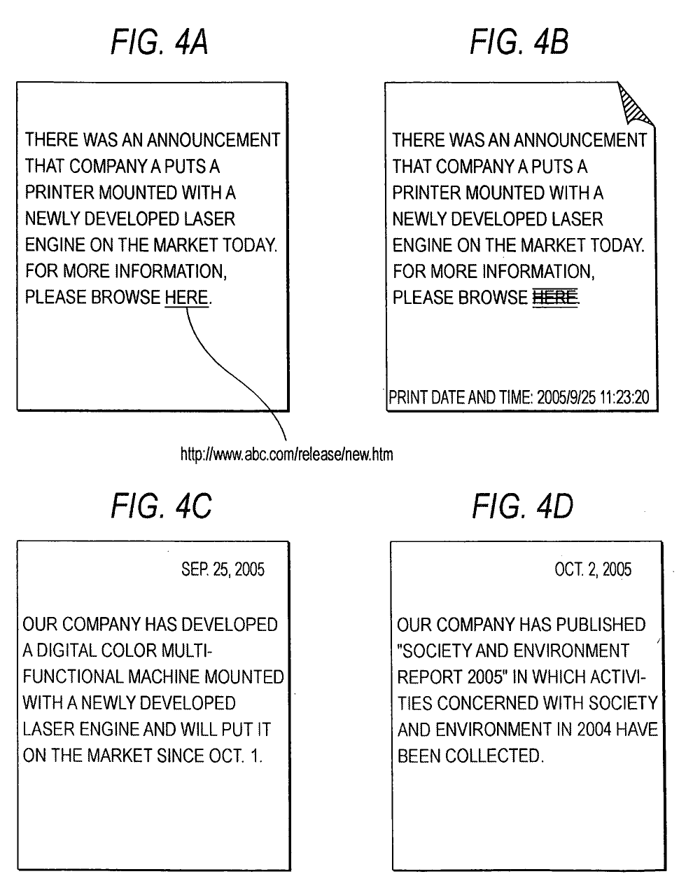

Assume as an example the case where a hypertext document as shown in FIG. 4A is printed out. When such a hypertext document is printed out, two-dimensionally coded link information “http://www.abc.com/release/new.htm” is overlaid and superposed on a portion of a character image 21 “here” in the printed-out image as shown in FIG. 4B. Assume that printout date and time is 2005/9/25 11:23:20. When the portion of the character image 21 is optically read and the link information is decoded and acquired from the reading result, contents relevant to the character image 21 as shown in FIG. 4C can be obtained by gaining access to an access destination specified by the link information.

The contents designated by the link information “http://www.abc.com/release/new.htm” may be however changed as shown in FIG. 4D because the contents are updated at a point of time (e.g. 2005/10/2) after the printing-out of the hypertext document. With regard to this point, the details of contents obtained by the access can be confirmed by use of the management information in the link information managing section 17.

That is, at the time of gaining access to the access destination specified by the link information and downloading the contents relevant to the character image 21 from the access destination, a hash value about the contents is calculated. A result of the calculation is compared with the hash value managed by the link information managing section 17 (i.e. the hash value calculated from the contents at the time of embedding the link information). On this occasion, the hash values coincide with each other if there is no updating/changing in the contents after the time point of printing out, but the hash values do not coincide with each other if there is updating/changing in the contents. That is, whether or not the content at the time of access are the same as the contents at the time of printing out can be checked based on a result of the comparison.

When the checking leads to a conclusion that the hash value at the time of access does not coincide with the hash value at the time of printing out (details of contents have been already updated), a pop-up dialog etc. is displayed together with the contents downloaded from the access destination in order to give notice of the updating of the contents to a viewer which has issued an instruction to gain access to the contents, so that the viewer can be informed of this notice. It can be conceived that such a pop-up dialog etc. may be displayed separately from the downloaded contents. In that case, the viewer is notified of the fact that the contents have been updated, and asked to decide whether or not to display the updated contents, so that the following processing can be achieved. That is, only when the viewer working on the operating device such as a keyboard performs a predetermined operation, the downloaded contents are displayed. Otherwise, the contents are not displayed.

On the other hand, when the hash value at the time of access coincides with the hash value at the time of printing out (details of the contents have not been updated yet), the popup dialog etc. is not displayed but the downloaded contents are displayed. Accordingly, the viewer browsing the contents can recognize access to the contents at the time of printing out, i.e. the expected contents because there is no notice by means of the popup dialog etc.

Since any known technique can be used for achieving detailed methods of downloading the contents, displaying the downloaded contents and the popup dialog, changing one display over to another display in accordance with the viewer's predetermined operation, etc., description thereof will be omitted here.

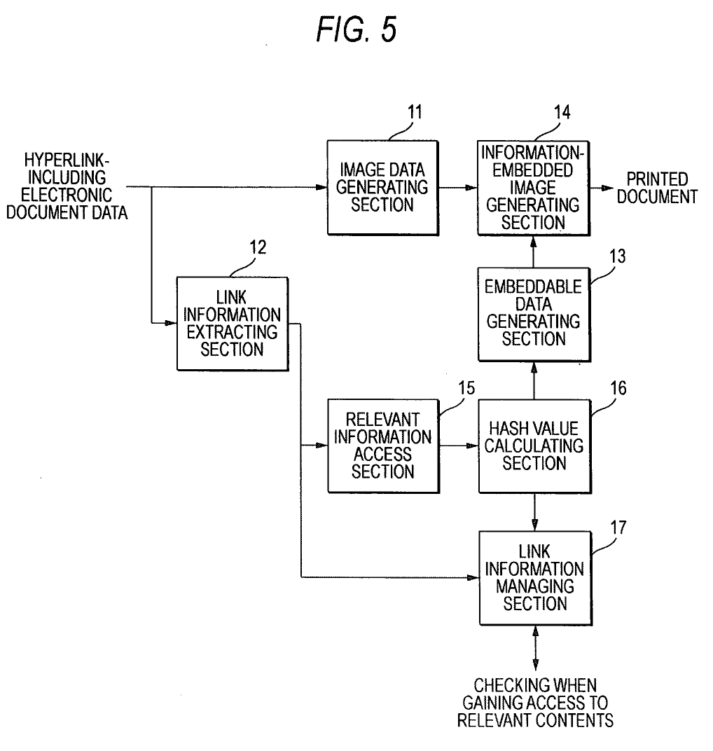

Next, another configuration example of the information processing apparatus will be described. FIG. 5 is an explanatory view showing a functional configuration of the information processing apparatus according to the second exemplary embodiment of the invention. Here, description will be only given to difference from the first exemplary embodiment.

As shown in FIG. 5, the second exemplary embodiment is different from the first exemplary embodiment in that not link information extracted by a link information extracting section 12 but a result of calculation of a hash value calculated by a hash value calculating section 16 for contents downloaded by a relevant information access section 15 based on the link information is converted into data in an embeddable format in a print image by the embeddable data generating section 13. Thus, an information-embedded image generating section 14 embeds the hash value about the contents, as information for specifying the relevant contents, into a printed image of a hypertext document. That is, because the hash value will become different unless details of the contents are totally identical, the hash value can be used as an identifier of the link information.

It is noted that the link information managing section 17 manages the link information while making correspondence between the link information and the hash value for the contents at the time of embedding the information.

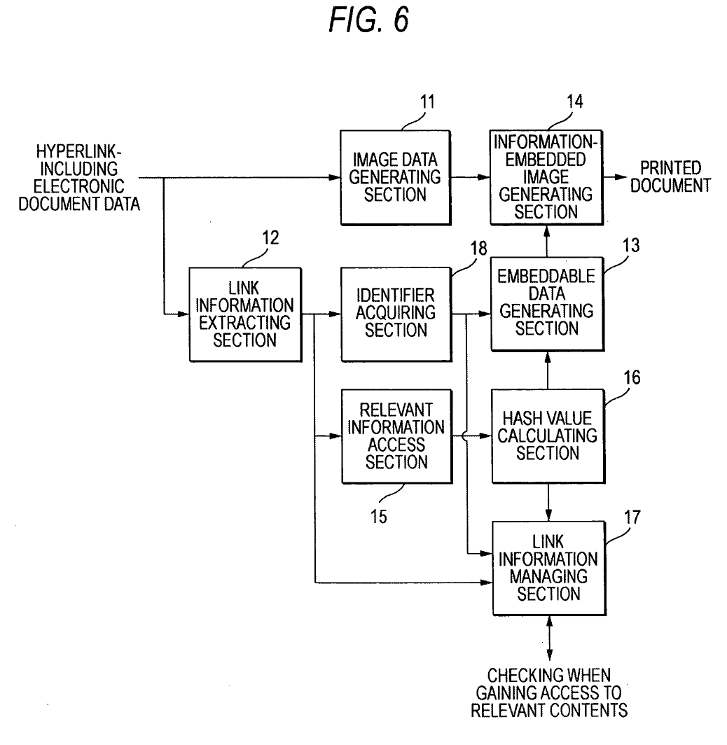

Next, a further configuration example of the information processing apparatus will be described. FIG. 6 is an explanatory view showing a functional configuration of the information processing apparatus according to the third exemplary embodiment of the invention. Here, description will be only given to difference from the first exemplary embodiment.

As shown in FIG. 6, the third exemplary embodiment is different from the first exemplary embodiment in that an identifier acquiring section 18 is provided. This identifier acquiring section 18 is for generating identifier information for uniquely specifying link information extracted by a link information extracting section 12. It can be conceived that a count value, for example, by a binary counter is used as the identifier information. Since an information quantity of about 5 bytes is sufficient for each count value by the binary counter, about one trillion kinds of link information can be identified and managed. This amount is enough in terms of the information quantity. Similarly to the respective sections 11 to 17, the identifier acquiring section 18 can be achieved by execution of a predetermined program.

Since the identifier acquiring section 18 is provided in the third exemplary embodiment, the embeddable data generating section 13 does not convert link information extracted by the link information extracting section 12 but converts identifier information generated by the identifier acquiring section 18 into data in an embeddable format corresponding to the link information. Thus, the information-embedded image generating section 14 embeds the identifier information for uniquely specifying the link information for the contents, as information for specifying the relevant contents, into a printed image.

In addition, in the third exemplary embodiment, the link information managing section 17 makes correspondence among link information extracted by the link information extracting section 12, a hash value calculated by the hash value calculating section 16 and identifier information generated by the identifier acquiring section 18, and stores and holds the correspondence relation among them.

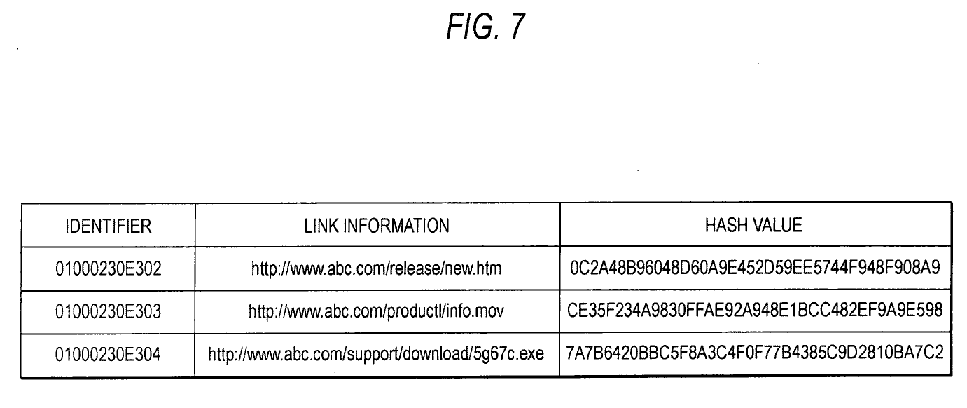

Here, description will be made on specific examples of correspondence relations among link information, hash values and identifier information. FIG. 7 is an explanatory view showing other specific examples of correspondence relations among link information, hash values and identifier information. As shown in FIG. 7, the link information managing section 17 stores the correspondence relations among the link information, the hash values and the identifier information in a table form. When, for example, a calculation result of a hash value about contents downloaded based on link information “http://www.abc.com/release/new.htm” is “0C2A48B96048D60A9E452D59EE5744F948F908A9” in the case where an identifier “01000230E302” is granted to the link information, the identifier, the link information and the hash value are registered in the table while correspondence is made among them.

When the link information, the hash value and the identifier information are managed thus while correspondence is made among them, the link information and the hash value corresponding to the identifier information can be specified accurately even in the case where the identifier information as information for specifying contents is embedded in a printed image. Accordingly, similarly to the first and second exemplary embodiments, whether or not contents at the time of access are the same as contents at the time of printing out can be checked without necessity of downloading, storing and holding the contents. Thus, even when details of the contents have been already changed, a viewer can make use of the contents without misunderstanding while grasping the change fact.

In addition, in the third exemplary embodiment, identifier information for uniquely identifying link information is used as information for specifying contents. Thus, use of the identifier information is also very effective in reducing the quantity of embedded information. That is, while the hash value requires at least 20-30 bytes, an information amount of about 5 bytes is sufficient for the identifier information so that the quantity of embedded information can be further reduced, compared with the case where the hash value is embedded. Hence, the identifier information is very suitable for maintenance of a good form of an image after information embedding. When, for example, “iTone (registered trademark)” is used as an information embedding technique, it can be conceived that information is embedded by use of the identifier information as information for specifying contents.

Although the aforementioned exemplary embodiments have been described on the case where the first to third exemplary embodiments are taken as specific examples for carrying out the invention, the invention is not limited thereto. Any suitable change can be made without departing from the gist of the invention.

What is claimed is:

1. An information processing apparatus comprising:
an information embedding section that embeds information, which specifies content relevant to document data, into the document data;
a feature quantity acquiring section that acquires feature quantity information about the content; and
an information managing section that manages the feature quantity information about the content at a time when the information is embedded into the document data, while associating the feature quantity information and the information embedded into the document data with each other.

2. The apparatus according to claim 1, wherein the information managing section compares the feature quantity information at the time when the information is embedded into the document data, with feature quantity information of the document data.

3. The apparatus according to claim 1, wherein:
the information managing section compares the feature quantity information at the time when the information is embedded into the document data, with feature quantity information of the document data,
when the information managing section judges, based on the comparison result, that the feature quantity information at the time the information is embedded into the document data and the feature quantity information of the document data are different, the information managing section notifies.

4. The apparatus according to claim 1, wherein the feature quantity acquiring section acquires a hash value of the content as the feature quantity information about the content.

5. The apparatus according to claim 1, wherein the information embedding section embeds into the document data link information about the content as the information, which specifies the content.

6. The apparatus according to claim 2, wherein the information embedding section embeds into the document data link information about the content as the information, which specifies the content.

7. The apparatus according to claim 3, wherein the information embedding section embeds into the document data link information about the content as the information, which specifies the content.

8. The apparatus according to claim 4, wherein the information embedding section embeds into the document data link information about the content as the information, which specifies the content.

9. The apparatus according to claim 1, wherein:
the information embedding section embeds into the document data the feature quantity information about the content as the information, which specifies the content; and
the information managing section manages the feature quantity information embedded into the document data while associating the embedded feature quantity information and link information about the content with each other.

10. The apparatus according to claim 2, wherein:
the information embedding section embeds into the document data the feature quantity information about the content as the information, which specifies the content; and
the information managing section manages the feature quantity information embedded into the document data while associating the embedded feature quantity information and link information about the content with each other.

11. The apparatus according to claim 3, wherein:
the information embedding section embeds into the document data the feature quantity information about the content as the information, which specifies the content; and
the information managing section manages the feature quantity information embedded into the document data while associating the embedded feature quantity information and link information about the content with each other.

12. The apparatus according to claim 4, wherein:
the information embedding section embeds into the document data the feature quantity information about the content as the information, which specifies the content; and
the information managing section manages the feature quantity information embedded into the document data while associating the embedded feature quantity information and link information about the content with each other.

13. The apparatus according to claim 1, wherein:
the information embedding section embeds into the document data identifier information, which uniquely specifies link information about the content as the information, which specifies the content; and
the information managing section manages the identifier information embedded into the document data while associating the identifier information and the link information specified by the identifier information with each other.

14. The apparatus according to claim 2, wherein:
the information embedding section embeds into the document data identifier information, which uniquely specifies link information about the content as the information, which specifies the content; and
the information managing section manages the identifier information embedded into the document data while associating the identifier information and the link information specified by the identifier information with each other.

15. The apparatus according to claim 3, wherein:
the information embedding section embeds into the document data identifier information, which uniquely specifies link information about the content as the information, which specifies the content; and
the information managing section manages the identifier information embedded into the document data while associating the identifier information and the link information specified by the identifier information with each other.

16. The apparatus according to claim 4, wherein:
the information embedding section embeds into the document data identifier information, which uniquely specifies link information about the content as the information, which specifies the content; and
the information managing section manages the identifier information embedded into the document data while associating the identifier information and the link information specified by the identifier information with each other.

17. A computer readable medium storing a program causing a computer to execute information processing, the information processing comprising:
embedding information, which specifies content relevant to document data, into the document data;
acquiring feature quantity information about the content; and
managing the feature quantity information about the content at a time when the information is embedded into the document data while associating the feature quantity information and the information embedded into the document data with each other.

18. A computer data signal embodied in a carrier wave for enabling a computer to perform information processing, the information processing comprising:
embedding information, which specifies content relevant to document data, into the document data;
acquiring feature quantity information about the content; and
managing the feature quantity information about the content at a time when the information is embedded into the document data while associating the feature quantity information and the information embedded into the document data with each other.

19. An information processing method comprising:
embedding information, which specifies content relevant to document data, into the document data;
acquiring feature quantity information about the content; and
managing the feature quantity information about the content at a time when the information is embedded into the document data while associating the feature quantity information and the information embedded into the document data with each other.
